(19) United States
(12) Patent Application Publication
(10) Pub. No.: US 2009/0204439 A1
(43) Pub. Date: Aug. 13, 2009

(54) Apparatus and method for managing electronic medical records embedded with decision support tools

(75) Inventor: Frederick E. Turton, Sarasota, FL (US)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: Emergent Health Technologies, LLC

(21) Appl. No.: 12/379,039

(22) Filed: Feb. 11, 2009

Related U.S. Application Data
(60) Provisional application No. 61/064,018, filed on Feb. 11, 2008.

(51) Int. Cl. G06Q 50/00; G06Q 30/00; G06Q 10/00; G06F 17/30

(52) U.S. Cl. 705/3; 705/2; 705/14; 705/11; 707/104.1; 707/10; 707/E17.044; 707/E17.005; 707/E17.032

(57) ABSTRACT

An apparatus and a method are provided for managing health care information. The apparatus includes a receiver configured to receive health care data from information sources, and a processor configured to assign pre-specified content and context to each datum of the received health care data to structure the received health care data. The apparatus further includes a transmitter configured to transmit the structured health care data to a data repository. The processor is configured to embed a decision support tool into an electronic medical record. The decision support tool includes the structured health care data stored in the data repository.

### CROSS REFERENCE TO RELATED APPLICATIONS

This application claims priority under 35 U.S.C. §119(e) of U.S. Provisional Patent Application Ser. No. 61/064,018, filed on Feb. 11, 2008. The subject matter of the earlier filed application is hereby incorporated by reference.

### BACKGROUND

1. Field

The invention relates to an apparatus and a method for managing health care information. More particularly, the invention relates to an apparatus and a method for managing health care information by structuring health care data as it is collected, and further for embedding decision support tools and other functionality including targeted advertising into electronic medical records (“EMRs”) and personal health records (“PHRs”) for facilitating the management of the data by health care providers, patients and industrial clients.

2. Description of the Related Art

With the advent of the Internet and advancements in technology access and security, health care providers are increasingly demanding the availability of different information technology systems and software applications to communicate and to utilize evidence-based medical data.

The electronic health record (“EHR”), also commonly referred to as the electronic medical record (“EMR”), was developed to store an individual patient's medical records in digital format. The EMR may include patient information, for example, patient demographics, medical history, medicine and allergy lists, laboratory test results, radiology images, billing records, physician diagnoses, and public health reporting.

As with most collected data, health care data lacks pre-specified content and context. In other words, health care data is unstructured when it is collected, regardless of whether it is contained within an EMR. FIG. 1 is an example of a physician-derived patient history, in accordance with current health care practices, and the difference between structured and unstructured patient data. As illustrated in FIG. 1, the physician may dictate the following: “A 50 year old Caucasian male presents today with a two week history of pressure-like left precordial chest pain that radiates to the left upper arm and is associated with nausea, diaphoresis, and dyspnea.” The physician may have no difficulty understanding the content and adding appropriate context to each data point. However, because the collected health care data is unstructured, its use is limited to other health care practitioners or health care facilities and cannot be manipulated in an electronic database. Once the data is structured it may be linked to a wide variety of other data including evidence-based medicine and targeted advertising.

Accordingly, what is needed is an apparatus and a method for structuring health care data by enforcing content and context on the health care data as it is collected. The health care data may be structured by assigning pre-specified content and context to each datum.

Furthermore, what is needed is an apparatus and a method for embedding decision support tools and other functionality including targeted advertising into an EMR and a PHR, whereby the decision support tool utilizes the structured health care data stored in a data repository.

Furthermore, what is needed is an apparatus and a method for normalizing the structured health care data with evidence-based information received from an evidence-based information source and for embedding a decision support tool utilizing the normalized health care data into an EMR, wherein the evidence-based information includes a link configured to provide a health care provider with current medical information.

Furthermore, what is needed is an apparatus and a method to produce benchmarking and population studies in a protected environment, to provide credentialing of health care providers in the protected environment, to integrate targeted advertising into an EMR, to reduce costs associated with the generation and use of EMRs, each to enhance the doctor/patient encounter.

### SUMMARY

In accordance with an embodiment of the invention, there is provided an apparatus for managing health care data. The apparatus includes a receiver configured to receive health care data from information sources, and a processor configured to assign pre-specified content and context to each datum of the received health care data to structure the received health care data. The processor further includes a transmitter configured to transmit the structured health care data to a data repository. The processor is configured to embed a decision support tool into an electronic medical record. The decision support tool includes the structured health care data stored in the data repository.

In accordance with another embodiment of the invention, there is provided an apparatus for managing health care data. The apparatus includes receiving means for receiving health care data from information sources, and processing means for assigning pre-specified content and context to each datum of the received health care data to structure the received health care data. The apparatus further includes transmitting means for transmitting the structured health care data to a data repository. The processing means is further for embedding a decision support tool into an electronic medical record. The decision support tool includes the structured health care data stored in the data repository.

In accordance with another embodiment of the invention, there is provided a method for managing health care data. The method includes receiving health care data from information sources, and assigning pre-specified content and context to each datum of the received health care data to structure the received health care data. The method further includes transmitting the structured health care data to a data repository, and embedding a decision support tool into an electronic medical record. The decision support tool includes the structured health care data stored in the data repository.

In accordance with another embodiment of the invention, there is provided a computer program product embodied on a computer readable medium. The computer program product is configured to control a processor to perform a process. The process includes receiving health care data from information sources, and assigning pre-specified content and context to each datum of the received health care data to structure the received health care data. The process further includes transmitting the structured health care data to a data repository, and embedding a decision support tool into an electronic medical record. The decision support tool includes the structured health care data stored in the data repository.

### BRIEF DESCRIPTION OF THE DRAWINGS

Further aspects, details, advantages and modifications of the present invention will become apparent from the following detailed description of the preferred embodiments which is to be taken in conjunction with the accompanying drawings, in which:

FIG. 1 is an example of a physician-derived patient history, in accordance with current health care practices, and the difference between structured and unstructured patient data.

FIG. 2 is a schematic block diagram of an apparatus, in accordance with an embodiment of the invention.

FIG. 3 is a schematic grid diagram of pre-specified content and context assigned to health care datum, in accordance with an embodiment of the invention.

FIG. 4 is a schematic grid diagram of structured health care data contained within overlapping categories, in accordance with an embodiment of the invention.

FIG. 5 is a schematic grid diagram of data manipulated by the apparatus illustrated in FIG. 2, in accordance with an embodiment of the invention.

FIG. 6 is an example of a blank progress note used by a health care practitioner in diagnosing a patient, in accordance with an embodiment of the invention.

FIG. 7 is an example of a progress note including a first set of diagnosis data entered, in accordance with an embodiment of the invention.

FIG. 8 is an example of a progress note including a second set of diagnosis data entered, in accordance with an embodiment of the invention.

FIG. 9 is an initial note for a patient diagnosed with diabetes Mellitus, Type 2, in accordance with an embodiment of the invention.

FIG. 10 is a note for the patient referred to in FIG. 9, during a subsequent medical visit, in accordance with an embodiment of the invention.

FIG. 11 is a health care management system, in accordance with an embodiment of the invention.

FIG. 12 is a provider benchmarking graph, in accordance with an embodiment of the invention.

FIG. 13 is a method for managing health care data, in accordance with an embodiment of the invention.

### DETAILED DESCRIPTION OF THE PREFERRED EMBODIMENTS

Reference will now be made in detail to the preferred embodiments of the present invention, examples of which are illustrated in the accompanying drawings.

Certain embodiments of the invention combine hardware and software components to create an apparatus and a method for managing health care data. Certain embodiments of the invention further provide an apparatus and a method for structuring the health care data by enforcing content and context on the health care data as it is collected. The health care data may be structured by assigning pre-specified content and context to each datum.

Furthermore, certain embodiments of the invention provide an apparatus and a method for embedding a decision support tool into an EMR, whereby the decision support tool includes the structured health care data stored in a data repository.

Furthermore, certain embodiments of the invention provide an apparatus and a method for normalizing the structured health care data with evidence-based information received from an evidence-based information source and for embedding a decision support tool including the normalized health care data into an EMR, wherein the evidence-based information includes a link configured to provide a health care provider with current medical information.

FIG. 2 is a schematic block diagram of an apparatus in accordance with an embodiment of the invention. The apparatus 100 may include a receiver 110, a processor 120, a transmitter 130.

The receiver 110 may be configured to receive health care data from information sources 140. The health care data may include, for example, a patient's demographics, a patient's medical history, physician prescribed medications, medicine and allergy lists, laboratory test results, radiology images, billing records, a physician's diagnosis of a patient, public health reporting, clinical data, electronic prescribing, a practice management resource, patient-provided health care information, medical evidence, advertising, educational material, and a publication.

The information sources 140 may include, for example, an electronic medical record 141, a patient interface or a “PHR” 142, a collaborating relationship 143, an evidence-based information source 144, an advertising source 145, and an agency 146. The collaborating relationship 143 may include, for example, a relationship with one of a provider of clinical data, a provider of an electronic prescribing, and a provider of a practice management resource. The agency 146 may include, for example, one of a certifying board, a licensing board, a credentialed practice location, and a commercial, research or publication customer.

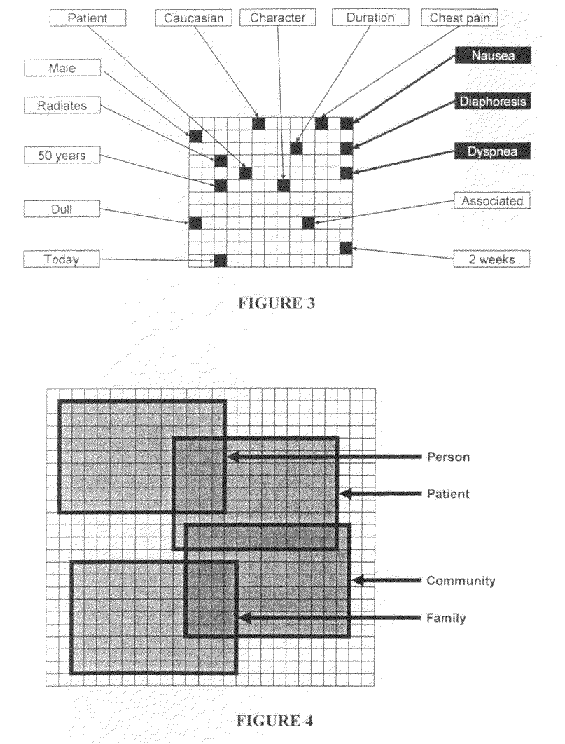

As previously noted above, most health care data is unstructured when it is collected. Accordingly, as illustrated in FIG. 3, the processor 120 may be configured to structure the received health care data by assigning pre-specified content and context to each datum of the received health care data. The transmitter 130 may be configured to transmit the structured health care data to a data repository 150.

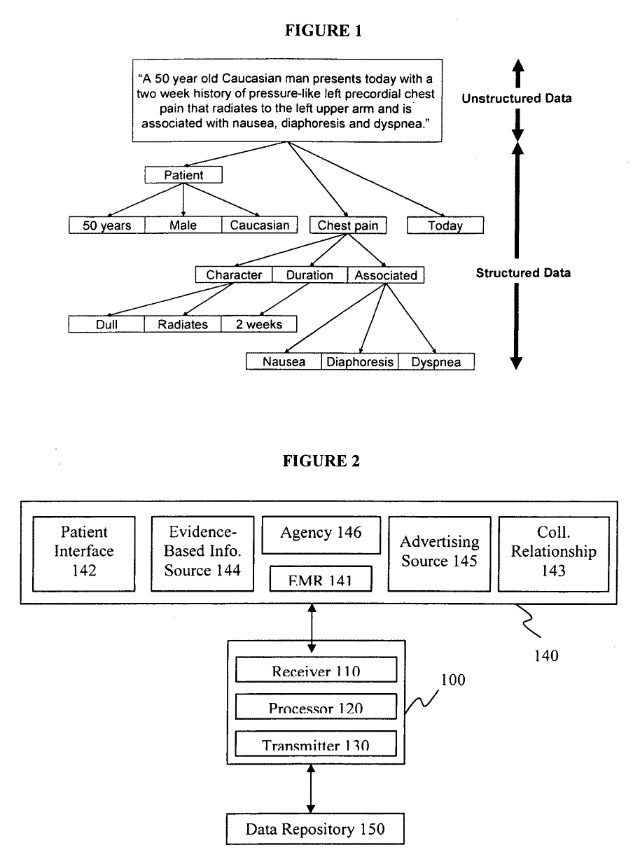

In particular, referring to the physician history discussed above and illustrated in FIG. 1, the processor 120 may be configured to specify a position in a database in the data repository 150 reserved for each symptom associated with a diagnosed condition, i.e., an initial symptom of chest pain, for example, “nausea,” “diaphoresis,” and “dyspnea,” each being symptoms of chest pain, as illustrated in FIG. 3.

The health care data may be structured in a way that mimics the way health care practitioners, health care facilities, and patients already define and categorize health care data. Because it is impossible to pre-select each and every type or category of health care data necessary to describe a patient's condition or the associated health care needed, the processor 120 may further be configured to add “new” data types or categories, including subcategories, as necessary, i.e., as defined by the health care provider.

The data may further be structured into categories, such as “person,” “patient,” “family,” “community,” “therapy,” and “analysis.” The category of “person” may include, for example, health care data related to a person's name, data of birth, sex, race, gender, etc. The category of “patient” may include sub-categories configured to store patient diagnosis information related to, for example, anatomy, physiology, and pathology. The subcategory of anatomy may include, for example, the location and structure associated with the patient's symptoms.

The structured data may include an overlap between various categories and subcategories of structured health care data, as illustrated in FIG. 4. Hence, FIG. 4 is a schematic grid diagram of structured health care data contained within overlapping categories, in accordance with an embodiment of the invention.

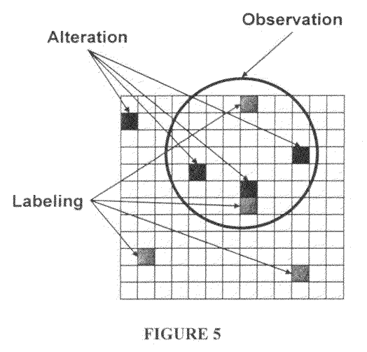

The processor 120 may further be configured to manipulate the structured health care data, as illustrated in FIG. 5. FIG. 5 is a schematic grid diagram of data manipulated by the apparatus 100 illustrated in FIG. 2, in accordance with an embodiment of the invention. Structured data may be manipulated by alteration, labeling, and observation. Alteration may include all changes to any of the data within the structured data, including, for example, the initial entry of unstructured health care data, any changes to the data, whether unstructured or structured, and erasure of the data from the processor 120. However, the structured health care data stored within the data repository 150 will seldom be erased. Labeling may include, for example, the addition of metadata (metadata is data about data). Observation may include, for example, data aggregation and reporting of data.

The processor 120 may further be configured to embed a decision support tool into the EMR 141. The decision support tool may include the structured health care data stored in the data repository 150.

The decision support tool may include links to a commercial or academic source of evidence-based information designed to provide a health care provider with current medical information. The health care provider may include, for example, a health care practitioner or a health care facility.

Further, the processor 120 may be configured to embed a patient-specific advertisement received from the advertising source 145 that may include a targeted advertisement for a patient based on a particular medical diagnosis.

Further, the processor 120 may be configured to normalize the structured health care data in the data repository 150 with evidence-based information received from an evidence-based information source 144, and further configured to embed a decision support tool including the normalized health care data into the EMR. As previously noted, the evidence-based information may include a link configured to provide a health care provider, for example, the health care practitioner or the health care facility, with current medical information.

The processor 120, in accordance with an embodiment of the invention, is unique in that it not only links to sources of evidence-based information, but actually is configured to integrate that information into the EMR 141. By integrating the evidence-based information into the EMR 141, the processor 120 is further able to customize the EMR 141 to the specific patient and to the specific time at which the patient is being treated.

There are a number of benefits associated with embedding a decision support tool into the EMR 141. Embedding a decision support tool into the EMR 141 may remove the need for a health care provider, such as a physician, to interrupt his or her workflow to consult an outside source of information about a patient's medical condition because the evidence-based information is already an integral part of the EMR 141. Furthermore, because the decision support tool is integrated into the EMR 141, health care practitioners less skilled or experienced than the physician, e.g., the mid-level provider or office nurses, may be able to gather pertinent information during the doctor-patient encounter without needing to consult the physician. Furthermore, the source of evidence-based decision support is externally generated and therefore may be modified as the evidence base of health care changes. Other benefits may include improved quality of care to the patient by the integration of imported health care data, enhanced accuracy and completeness of health care data, and a reduction in redundant and inappropriate health care gathering.

The transmitter 130 may further be configured to assign a datum of the structured health care data to a data field in the data repository 150 reserved for a specific category related to a patient's condition or an associated health care need for the patient's condition. A plurality of the data may be configured to represent one of a health care provider's diagnosis of a patient's condition or the associated health care needed for the patient's condition.

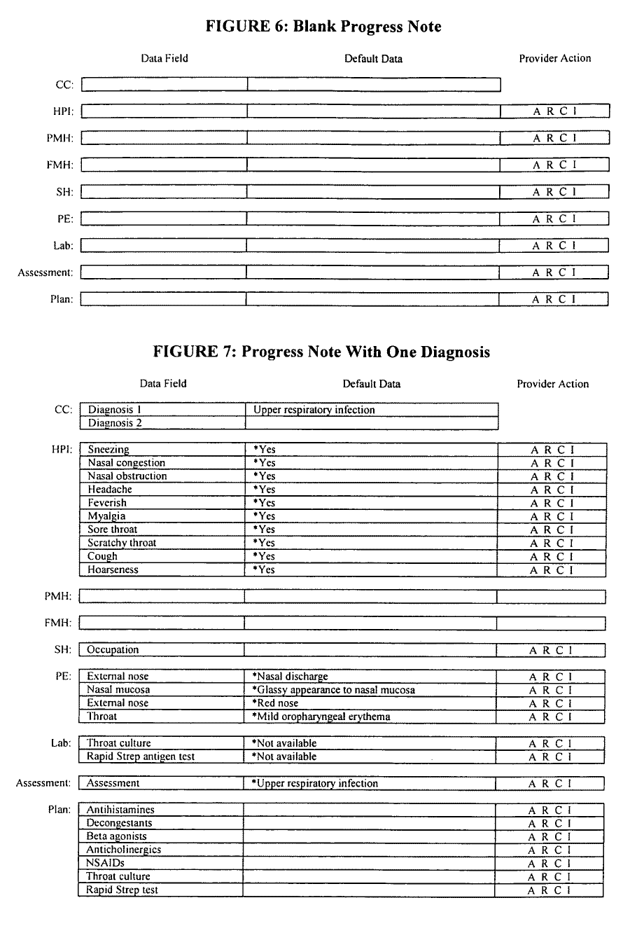

FIG. 6 is an example of a blank progress note used by a health care practitioner in diagnosing a patient, in accordance with an embodiment of the invention. The blank progress note may include a working area arranged to include the usual features of a health care practitioner's progress note. The note may include chief complaint (“CC”), history of present illness (“HPI”), past medical history (“PMH”), family medical history (“FMH”), social history (“SH”), physical examination (“PE”), laboratory values (“Lab”), final assessment (“Assessment”), and plan (“Plan”). In the area of the note called “Provider Action,” the member of the provider team may: “A”—accept the default entry, “R”—reject the default entry, “C”—change the default entry, or “I”—request information from the data source to assist in understanding the default data entry suggestion. Not every part of the patient progress note may have data assigned to it. In these examples, FMH may not have default data added because FMH may not be pertinent to either of these diagnoses. In all cases where the data fields are empty, the provider may insert data or leave it blank.

FIG. 7 is an example of a progress note including a first set of diagnosis data entered, in accordance with an embodiment of the invention. In FIG. 7, the diagnosis of “Upper respiratory infection” has been made by the doctor at the EMR 141 and inserted as Diagnosis 1. The data fields may be populated with evidence-based data by the processor 120 in response to the provider entering a diagnosis. The evidence-based data, derived from evidence-based information source 144, for this diagnosis may be allocated to the areas of the progress note where it applies and default data entries are entered. When the provider team member interviews and examines the patient, she may have the opportunity to accept, reject (and enter other data) or change the default entry. She may also request more information about that particular data field.

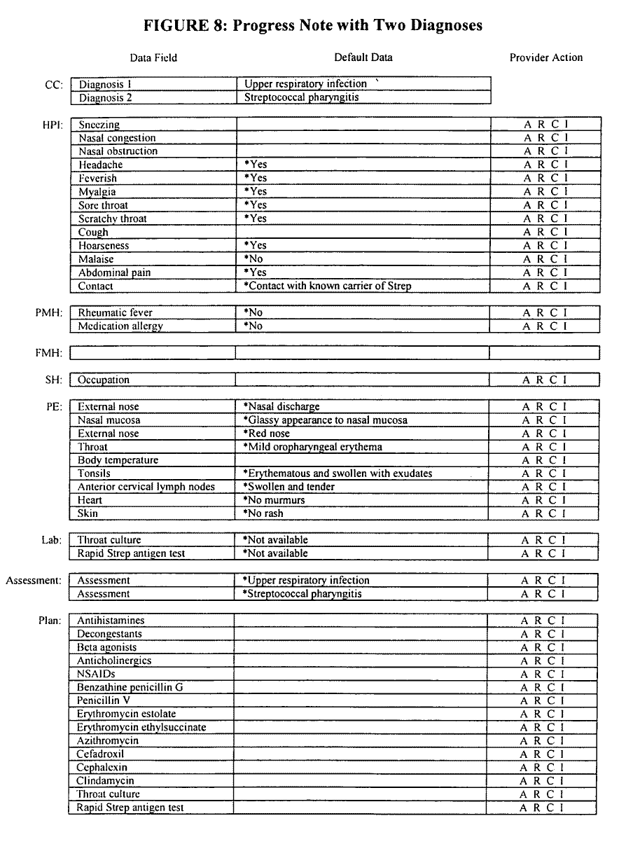

FIG. 8 is an example of a progress note including a second set of diagnosis data entered by the doctor into the EMR 141, in accordance with an embodiment of the invention. In FIG. 8, the diagnosis “Streptococcal pharyngitis” has been selected in addition to “Upper respiratory infection.” Where the second diagnosis calls for another data field, it may be added. If the second diagnosis shares data fields with the first diagnosis, it may not be redundantly added. Where the two diagnoses have default entries that are different, the data field may be left blank. The information provided by the “I” in the provider action column may link to data supplied by the evidence-based information source 144. With this, the health care provider may summon information specific to that particular data point for that particular diagnosis from the evidence-based information source 144.

The processor 120 may further be configured to perform data reconciliation. Data reconciliation is a technique that is used to minimize the time and effort needed to enter data into a progress note/chart and to make sure that collected data from a previous diagnosis or medical visit is available at a proper time. When a patient is seen for the first time, the processor 120 may be configured to enter data into the appropriate data fields. When the patient is seen on subsequent visits, the processor 120 may be configured to utilize an embedded decision support tool to populate data fields with pre-determined data. Therefore, only the fields that do not contain data or that require updating of data need the attention of the health care practitioner diagnosing the patient.

There are numerous benefits of data reconciliation. These benefits may include the need for data to only be entered once, a reduction of time and resources needed by the health care practitioner in treating the patient, a reduction in data entry errors, and automatic alerts provided to health care practitioners when there are changes in the data fields. The processor 120 being configured to perform data reconciliation may permit a health care provider to focus on the changes that have occurred in the patient's circumstances, while minimizing the amount of data entry needed at each patient's medical visit.

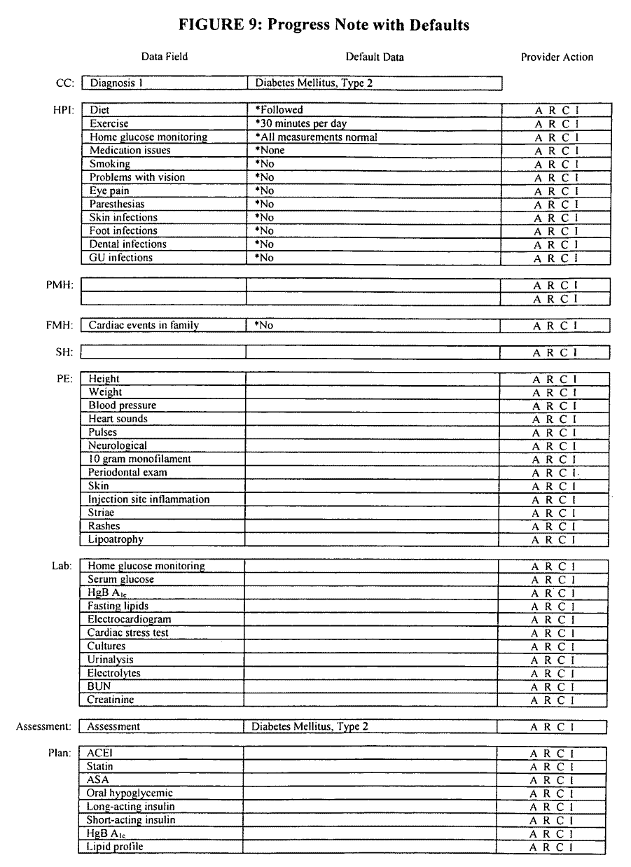

FIG. 9 is an initial note for a patient diagnosed with diabetes Mellitus, Type 2, in accordance with an embodiment of the invention. FIG. 9 illustrates that the embedded decision support tool may populate the note with the data fields that are pertinent to this diagnosis and with default data, when it is appropriate. This function is initiated at the EMR 141 and then the needed information is drawn from the evidence-based information source 144.

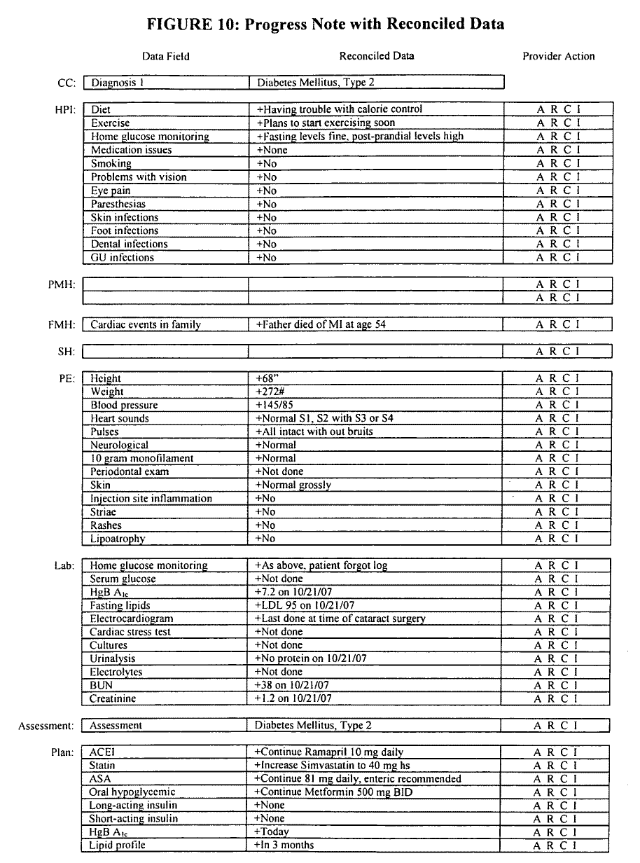

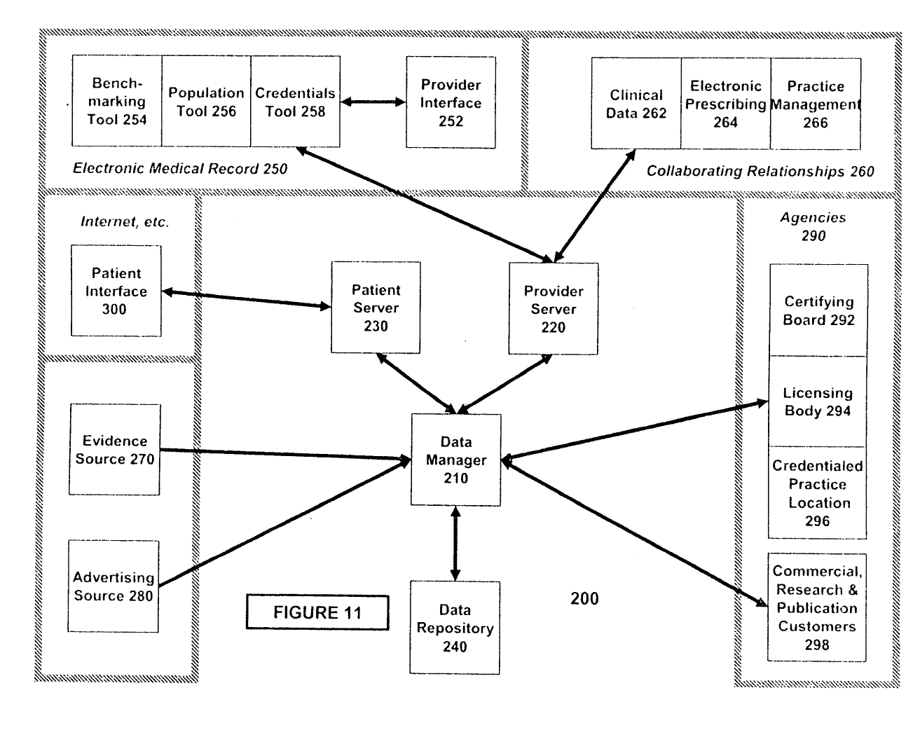

FIG. 10 is a note for the patient referred to in FIG. 9, during a subsequent medical visit, in accordance with an embodiment of the invention. The data in each data field may be the data that was collected on a previous visit either by accepting the default data or entering new data. The data that is reconciled forward to the new note may be indicated for the provider's information with a “+”. Again the provider may be given the opportunity to accept, reject or change the reconciled data. Specific information for each data field may remain available to the health care provider.

The processor 120 may further be configured to de-identify and re-identify the structured health care data in accordance with the highest ethical standards and the Health Insurance Portability and Accountability Act enacted by the U.S. Congress in 1986 (“HIPAA”).

In particular, the processor 120 may be configured to de-identify the structured health care data when the structured health care data is to be transmitted to an unsecure area. The unsecure area may include, for example, one of the data repository 150 and an agency 146. As previously noted, the agency 146 may include, for example, one of a certifying board, a licensing board, a credentialed practice location, and a commercial, research or publication customer.

The processor 120 may be further configured to re-identify the structured health care data when the structured health care data is received from the data repository 150, i.e., when the data is need to determine benchmarking, population management, or credential management. Thus, the structured health care data may be converted into protected health care data in accordance with HIPAA standards.

FIG. 11 is a health care management system, in accordance with an embodiment of the invention. In FIG. 11, the apparatus and the data repository discussed above may be utilized to structure received health care data from information sources, to embed a decision support tool into an EMR, and to normalize the structured health care data stored in the data repository, whereby the normalized health care data may be included in a decision support tool that is embedded into the EMR.

The system 200 may include the apparatus and the data depository described above, whereby the apparatus serves as a data manager 210 for the health care management system 200. The system 200 may further include a provider server 220, a patient server 230, and the data repository 240 discussed above and illustrated in FIG. 2. The system 200 may further include an EMR 250, a collaborative relationship 260 with a health care entity, an evidence-based information source 270, an advertising source 280, an agency 290, and a patient interface 300.

The provider server 220 may be configured to store and manage data received from the EMR 250 and/or a collaborating relationship 260. The data may include, for example, a provider's patient health care data. The patient health care data may include, for example, patient demographics, patient medical history, physician proscribed medications, medicine and allergy lists, laboratory test results, radiology images, billing records, physician diagnoses, clinical data, electronic prescribing, a practice management resource, and public health reporting.

Furthermore, the patient health care data may be protected or unprotected data, whereby the protected data may be encrypted. The provider server 220 may be partitioned into a secure area and an unsecured area, whereby the secure area may include the patient health care data.

The provider server 220 may further be configured to manage data received via a collaborative relationship 260 with a health care provider. The health care provider may include, for example, a health care practitioner or a health care facility, as defined above. The health care practitioner may include, for example, an administrative component of a health care practitioner's practice, such as an accounting office of a physician's practice. The health care facility may include, for example, a laboratory, an imaging center, a hospital, or a nursing home.

The provider server 220 may further be configured to interact with a provider interface 252 of the EMR 250, a benchmarking tool 254 of the EMR 250, a population tool 256 of the EMR 250, a credentials tool 258 of the EMR 250, a source of clinical data 262, a source of electronic prescribing 264, a practice management source 266, and the data manager 210, to be discussed in more detail below.

The patient server 230 may be configured to interface with a patient interface 300 via the Internet to provide a patient with access to his or her health care data. The patient server 230 provides the patient with the ability to monitor and manage his or her own health care data and the services associated therewith. The patient server 230 may also be called a PHR.

The patient server 230 may further be configured to provide the patient with health care data that is provided at the provider interface 252 of the EMR 250. The health care data in the patient server 230 may be provided by the health care physician or the patient. For example, the health care data may include a physician's diagnosis of the patient, physician proscribed medications, and results of testing and education material. The health care data in the patient server 230 may further include, for example, biological data provided by a patient at the patient interface, whereby the biological data may include, for example, blood pressure, home glucose values, spirometric values, and body weight. The health care data may further include benchmarking and population data.

Further, the patient server 230 may be configured to provide a secure line of communication between the health care physician and the patient. The patient server 230 may be a secure component, whereby all data contained within and email communication facilitated by the patient server 230 may be encrypted and accessed only by mutual consensus between a provider team of health care physicians, the patient, and other individuals who may be involved in the patient's care, e.g., family members or qualified care-takers.

The EMR 250 may include a provider interface 252, a benchmarking tool 254, a population tool 256, and a credentials tool 258. The provider interface 252 may include one or more computers to be used by a health care provider, and configured to provide the health care provider with the ability to interact with a patient. The provider interface 252 may further be configured to document patient care and to utilize embedded decision support tools, targeted advertising, and data reconciliation to manage the patient's health care data. The provider interface 252 may further be configured to interact with the provider sever 220.

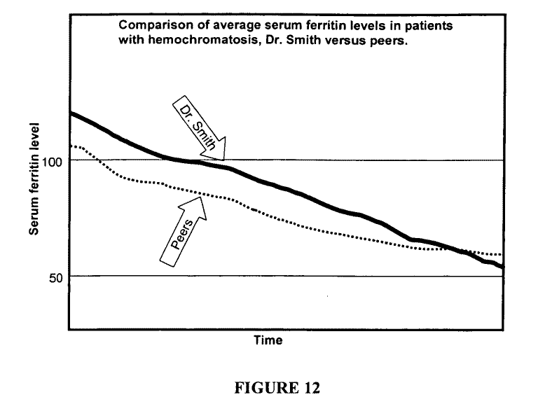

The benchmarking tool 254 may be configured to identify a performance change of a provider over time and to set future goals for performance improvements. The benchmarking tool 254 may include standard measures that may be derived from an evidence source 270. Further, the benchmarking tool 254 may be configured to generate reports based either on the standard measures or on custom measures generated by the health care provider or a credentialing health care body. The benchmarking tool 254 may also be configured to develop contingent reports that analyze developing trends. These reports may be repeatable over time, but are not stored in the system 200. The benchmarking tool 254 may be connected to the data repository 240 via the data manager 210, allowing a provider team to compare its performance to its peers, as illustrated in FIG. 12. FIG. 12 is a provider benchmarking graph, in accordance with an embodiment of the invention. FIG. 12 is a graph of serum ferritin levels in patients with hemochromatosis versus time, illustrating the average serum ferritin level of Dr. Smith's patients with hemochromatosis compared to the average serum ferritin level of his peers' patients with hemochromatosis over time. The benchmarking tool 254 may interact with the provider server 220.

The population tool 256 may be configured to assemble and review clinical data accumulated during a health care physician's interaction with a patient, i.e., during a physician's care of a patient. The population tool 256 is further configured to generate a list of patients, e.g., patient registries, and a reminder of services needed, and to make the information available to both the provider team and the patient. The population tool 256 is configured to interact with the provider server 220.

The credentials tool 258 may be configured to transmit data accumulated during the health care physician's interaction with a patient to a variety of individual credentialing bodies, for example, a certification board, a licensing entity, and other credentialed practice locations. The credentials tool 258 is configured to interact with the provider server 220.

A collaborative relationship 260 with a health care provider is provided to further facilitate the structuring of health care data contained within the EMR 250 by the data manager 210, i.e., the health care data might be metadata, supplementing the structured health care data stored within the data repository 240. Accordingly, the data manager 210 may be configured to embed a decision support tool into the EMR 250 that includes the structured health care data stored within the data repository 240 that has been supplemented with the metadata received from the health care provider via the collaborative relationship 260. This health care data may include, for example, laboratory values, imaging results, communications with other health care practitioners and health care facilities, and information provided by the patient at the patient server 230, an evidence source 270, an advertising source 280, and an agency 290.

Using this structured health care data, the data manager 210 may be configured to generate benchmarking and population studies in a protected environment, to provide credentialing of health care practitioners and health care facilities in the protected environment, to integrate targeted advertising, and to reduce costs associated with the generation and use of EMRs.

The health care provider, discussed above, may include, for example, a health care practitioner or a health care facility. The health care practitioner may include, for example, an administrative component of a health care practitioner's practice, such as an accounting office of a physician's practice. The health care facility may include, for example, a laboratory, an imaging center, a hospital, or a nursing home.

The system 200 may further include evidence sources 270 and advertising sources 280. An evidence source 270 may be configured to provide a source of evidence-based medicine that is a critical source of clinical information. The data manager 210 may be configured to convert this clinical information into embedded decision support. The evidence source 270 may also be configured to provide independent diagnosis-based health maintenance-based data and other clinical, educational and health care information. Further, the evidence source 270 may be configured to interact with the data manager 210.

An advertising source 280 may include, for example, a pharmaceutical company or other entity that would benefit commercially from exposure to health care practitioners and patients. The advertising source 280 may be configured to provide independent diagnosis-based health maintenance-based data in the form of advertisements into the patient chart when the patient has a particular diagnosis, and when the health care provider is engaging the patient in discussion, examination, or treatment of that specific medical diagnosis. The advertising source 280 may further be configured to minimize inapplicable advertising. The benefits of the advertising source 280, in accordance with an embodiment of the invention, is that the health care provider only sees advertising that applies to the patient he is seeing, allowing the pharmaceutical company to be helpful in the care of patients. Furthermore, the advertising source 280 minimizes the occurrence that the health care provider is exposed to advertising that is not pertinent to his/her patient, reducing the chance of an inappropriate prescription being prescribed. The advertising source 280 may be configured to interact with the data manager 210.

The system 200 may also include agencies 290. An agency 290 may be configured to evaluate a health care practitioner's performance and to grant a certification, license, or credential to the health care practitioner, or further configured to use the structured health care data stored within the data repository 240 for academic or commercial purposes. An agency 290 may include a certifying board 292, for example, the American Board of Internal Medicine. Information generated by the provider interface 252, the benchmarking tool 254, and the population tool 256 may be transmitted to the certifying board 292. The information may be passed through the data manager 210, de-identified, and transmitted, upon the provider's full permission, to the certifying board 292. An agency 290 may also include a licensing body 294, for example, a state medical board, and a credentialed practice location 296, for example, a hospital. Information generated by the provider interface 252, the benchmarking tool 254, and the population tool 256 may also be transmitted to the licensing body 294 and the credentialed practice location 296.

Health care data structured by the data manager 210 and stored in the data repository 240 may be highly valuable to a variety of commercial, research and publication customers 298. The data manager 210 may be configured to de-identify the structured health data and transmit the data to the commercial, research and publication customers 298 for commercial purposes, health care research, and use in publications. Structured health care data may be de-identified within the standards of HIPAA. The commercial, research and publication customers 298 may be configured to receive this health care data, to generate informational products, and to transmit these information sources to the patient server 230 or the provider server 220 for use at a patient interface 300, the provider interface 252, or by the benchmarking tool 254, the population tool 256, and the credentials tool 258.

A patient may interface with the patient server 230 via the patient interface 300 over the Internet. The patient interface 300 (also called a PHR) may include, for example, a user equipment, a personal computer, or handheld device, such as a mobile telephone or personal digital assistant, or their equivalents. The patient interface 300 may be configured to receive information generated by the provider server 220 or the data manager 210, and further configured to provide bi-directional communication between the provider team and the patient. The patient interface 300 may be configured to communicate with the patient server 230.

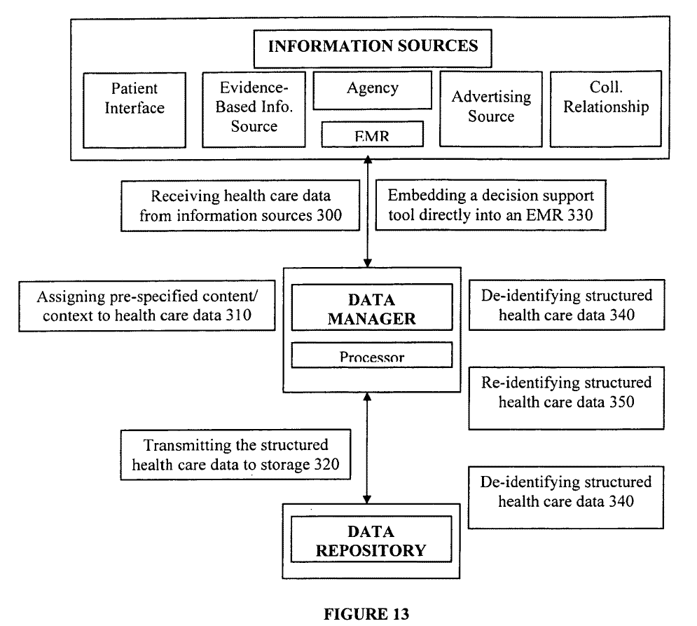

FIG. 13 is a method for managing health care data, in accordance with an embodiment of the invention. At step 300, the processor of the data manager may receive health care data from information sources.

The step of receiving may include receiving the health care data from the information sources including one of an electronic medical record, a patient interface, a collaborating relationship, an evidence-based information source, an advertising source, and an agency. The collaborating relationship may include, for example, a relationship with one of a provider of clinical data, a provider of an electronic prescribing, and a provider of a practice management resource. The agency may include, for example, one of a certifying board, a licensing board, a credentialed practice location, and a commercial, research or publication customer.

The health care data may include, for example, a patient's demographics, a patient's medical history, physician prescribed medications, medicine and allergy lists, laboratory test results, radiology images, billing records, a physician's diagnosis of a patient, public health reporting, clinical data, electronic prescribing, a practice management resource, patient-provided health care information, medical evidence, advertising, educational material, and a publication. The health care data may be protected or unprotected data, whereby the protected data may be encrypted.

At step 310, the processor of the data manager may assign pre-specified content and context to each datum of the received health care data to structure the received health care data. The structuring of the health care data may further include assigning a datum of the structured health care data to a data field in a database reserved for a specific category related to a patient's condition or an associated health care needed for the patient's condition. A plurality of data may represent one of a health care practitioner's diagnoses of the patient's condition or the associated health care needed for the patient's condition.

At step 320, the processor of the data manager may transmit the structured health care data to a data repository.

At step 330, the processor of the data manager may embed a decision support tool into an electronic medical record. The decision support tool may include the structured health care data stored in the data repository. The decision support tool may also include links to a commercial or academic source of evidence-based information designed to provide a health care provider with current medical information. The health care provider may include, for example, a health care practitioner or a health care facility.

Further, the processor 120 may be configured to embed a patient-specific advertisement received from the advertising source 145 that may include a targeted advertisement for a patient based on a particular medical diagnosis. The step of structuring the health care data may further include normalizing the structured health care data in the data repository with evidence-based information received from an evidence-based information source. The step of embedding the decision support tool into the electronic medical record may include configuring the decision support tool to include the normalized health care data. The evidence-based information may include a link configured to provide a health care provider with current medical information.

At step 340, the processor of the data manager may de-identify the structured health care data when the structured health care data is transmitted to an unsecure area, such as the data repository or an outside agency. The step of de-identifying the structured health care data may be performed in accordance with the highest ethical standards and the Health Insurance Portability and Accountability Act enacted by the U.S. Congress in 1986 (“HIPAA”).

At step 350, the processor of the data manager may re-identify the structured health care data when the structured health care data is received from the data repository and moved into the secure area of the data manager. The structured health care data may need to be re-identified so that benchmarking, population management, or credential management may be performed.

In accordance with an embodiment of the invention, a computer program product embodied on a computer-readable medium may also be provided, whereby encoded instructions for performing at least the method described in FIG. 13, in accordance with an embodiment of the invention, is provided.

The computer program product may be implemented in hardware components, software components, or a hybrid implementation of hardware components and software components. The computer program product may be composed of modules that are in operative communication with one another, and which are designed to pass information or instructions to a communications device, such as a user equipment, a personal computer, or handheld device, such as a mobile telephone or personal digital assistant, or their equivalents. The computer program product may be configured to operate on a general purpose computer or an application specific integrated circuit (ASIC).

The computer-readable medium may include, for example, a disk media computer memory, and other storage devices.

As used above, computer may be any microprocessor or processor controlled device that permits access to the Internet, including terminal devices, such as personal computers, workstations, servers, clients, mini computers, main-frame computers, laptop computers, a network of individual computers, mobile computers, palm-top computers, hand-held computers, set top boxes for a TV, interactive televisions, interactive kiosks, personal digital assistants, interactive wireless communications devices, mobile browsers, or a combination thereof. The computer may further have input devices, for example, a keyboard, mouse, touchpad, joystick, pen-input-pad, output devices, for example, a computer screen and a speaker, fingerprint readers, touchscreens, label printers, and the like.

The computer may be a uni-processor or multi-processor machine. Additionally, the computer may include an addressable storage medium or computer accessible medium, such as random access memory (RAM), an electronically erasable programmable read-only memory (EEPROM), programmable read-only memory (PROM), erasable programmable read-only memory (EPROM), hard disks, floppy disks, laser disk players, digital video devices, compact disks, video tapes, audio tapes, magnetic recording tracks, electronic networks, and other techniques to transmit or store electronic content, for example, programs and data. The computer may be equipped with a network communication device, for example, a network interface card, a modem, or other network connection device suitable for connecting to a networked communication medium.

Furthermore, the computer may execute an appropriate operating system such as Linux, Unix, Microsoft® Windows®, Apple® MacOS®, or IBM® OS/2®. The appropriate operating system may include a communications protocol implementation which handles all incoming and outgoing message traffic passed over the Internet. While the operating system may differ depending on the type of computer, the operating system can continue to provide the appropriate communications protocols necessary to establish communication links with the Internet.

The computers may include program logic, or other substrate configuration representing data and instructions, which cause the computer to operate in a specific and predefined manner as described herein. The program logic may be implemented as one or more modules. The modules may be configured to reside on the addressable storage medium and configured to execute on one or more processors. The modules include, but are not limited to, software or hardware components which perform certain tasks.

“Internet” refers to a network or combination of networks spanning any geographical area, such as a local area network, wide area network, regional network, national network, and/or global network. As used herein, “Internet” may refer to hardwire networks, wireless networks, or a combination of hardwire and wireless networks. Hardwire networks may include, for example, fiber optic lines, cable lines, ISDN lines, copper lines, etc. Wireless networks may include, for example, cellular systems, personal communication services (PCS) systems, satellite communication systems, packet radio systems, and mobile broadband systems. A cellular system may use, for example, code division multiple access (CDMA), time division multiple access (TDMA), personal digital phone (PDC), Global System Mobile (GSM), or frequency division multiple access (FDMA), among others.

It is to be understood that in the embodiment of the invention, the steps are performed in the sequence and manner as shown although the order of some steps and the like may be changed without departing from the spirit and scope of the present invention. In addition, the methods described in FIG. 13 may be repeated as many times as needed.

The many features of the invention are apparent from the detailed specification and, thus, it is intended by the appended claims to cover all such features of the invention which fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

We claim:

1. An apparatus, comprising:
a receiver configured to receive health care data from information sources;
a processor configured to assign pre-specified content and context to each datum of the received health care data to structure the received health care data; and
a transmitter configured to transmit the structured health care data to a data repository,
wherein the processor is configured to embed a decision support tool into an electronic medical record, wherein the decision support tool comprises the structured health care data stored in the data repository.

2. The apparatus of claim 1, wherein the processor is further configured to embed a decision support tool comprising a link to a commercial or academic source of evidence-based information into the electronic medical record, wherein the link is configured to provide a health care provider with current medical information.

3. The apparatus of claim 1, wherein the processor is further configured to embed a patient-specific advertisement into the electronic medical record, wherein the patient-specific advertisement comprises a targeted advertisement for a patient based on a particular medical diagnosis

4. The apparatus of claim 1, wherein the processor is further configured to normalize the structured health care data in the data repository with evidence-based information received from an evidence-based information source, and to embed a decision support tool comprising the normalized health care data into the electronic medical record, wherein the evidence-based information comprises a link configured to provide a health care provider with current medical information.

5. The apparatus of claim 1, wherein the information sources comprise one of an electronic medical record, a patient interface, a collaborating relationship, an evidence-based information source, an advertising source, and an agency.

6. The apparatus of claim 5, wherein the collaborating relationship comprises a relationship with one of a provider of clinical data, a provider of an electronic prescribing, and a provider of a practice management resource.

7. The apparatus of claim 5, wherein the agency comprises one of a certifying board, a licensing board, a credentialed practice location, and a commercial, research or publication customer.

8. The apparatus of claim 1, wherein the transmitter is further configured to assign a datum of the structured health care data to a data field in the data repository reserved for a specific category related to a patient's condition or an associated health care need for the patient's condition, wherein a plurality of the data are configured to represent one of a health care provider's diagnosis of a patient's condition and the associated health care needed for the patient's condition.

9. The apparatus of claim 1, wherein the processor is further configured to de-identify and re-identify the structured health care data.

10. The apparatus of claim 9, wherein the processor is further configured to de-identify the structured health care data when the structured health care data is to be transmitted to an unsecure area, wherein the unsecure area comprises one of the data repository and an agency, wherein the agency comprises one of a certifying board, a licensing board, a credentialed practice location, and a commercial, research or publication customer.

11. The apparatus of claim 9, wherein the processor is further configured to re-identify the structured health care data when the structured health care data is received from the data repository.

12. The apparatus of claim 1, wherein the receiver is further configured to receive health care data comprising one of a patient's demographics, a patient's medical history, physician prescribed medications, medicine and allergy lists, laboratory test results, radiology images, billing records, a physician's diagnosis of a patient, public health reporting, clinical data, electronic prescribing, a practice management resource, patient-provided health care information, medical evidence, advertising, educational material, and a publication.

13. The apparatus of claim 1, wherein the transmitter is further configured to transmit data accumulated during a health care provider's interaction with a patient to at least one credentialing body, wherein the at least one credentialing body comprises a certification board, a licensing entity, and other credentialed practice locations.

14. The apparatus of claim 1, wherein the transmitter is further configured to transmit data accumulated during a health care provider's interaction with a patient to a benchmarking tool, wherein the benchmarking tool is configured to compare the accumulated data with structured health care data stored within the data repository to identify a performance change of the health care provider over time and to set future goals for performance improvements for the health care provider.

15. The apparatus of claim 1, wherein the transmitter is further configured to transmit the structured health care data stored within the data repository to commercial, research and publication customers for commercial purposes, health care research, and use in publications.

16. An apparatus, comprising:
receiving means for receiving health care data from information sources;
processing means for assigning pre-specified content and context to each datum of the received health care data to structure the received health care data; and
transmitting means for transmitting the structured health care data to a data repository,
wherein the processing means is further for embedding a decision support tool into an electronic medical record, wherein the decision support tool comprises the structured health care data stored in the data repository.

17. A method for managing health care data, comprising:
receiving health care data from information sources;
assigning pre-specified content and context to each datum of the received health care data to structure the received health care data;
transmitting the structured health care data to a data repository; and
embedding a decision support tool into an electronic medical record, wherein the decision support tool comprises the structured health care data stored in the data repository.

18. The method of claim 17, wherein the embedding of the decision support tool into the electronic medical record comprises configuring the decision support tool to comprise one of a link to a commercial or academic source of evidence-based information into the electronic medical record, wherein the link is configured to provide a health care provider with current medical information.

19. The method of claim 17, further comprising:
embedding a patient-specific advertisement into the electronic medical record, wherein the patient-specific advertisement comprises a targeted advertisement for a patient based on a particular medical diagnosis.

20. The method of claim 17, further comprising:
normalizing the structured health care data in the data repository with evidence-based information received from an evidence-based information source,
wherein the embedding of the decision support tool into the electronic medical record comprises configuring the decision support tool to comprise the normalized health care data, and
wherein the evidence-based information comprises a link configured to provide a health care provider with current medical information.

21. The method of claim 17, wherein the receiving comprises receiving the health care data from the information sources comprising one of an electronic medical record, a patient interface, a collaborating relationship, an evidence-based information source, an advertising source, and an agency.

22. The method of claim 21, wherein the collaborating relationship comprises a relationship with one of a provider of clinical data, a provider of an electronic prescribing, and a provider of a practice management resource.

23. The method of claim 21, wherein the agency comprises one of a certifying board, a licensing board, a credentialed practice location, and a commercial, research or publication customer.

24. The method of claim 17, wherein the transmitting further comprises assigning a datum of the structured health care data to a data field in the data repository reserved for a specific category related to a patient's condition or an associated health care need for the patient's condition, wherein a plurality of the data are configured to represent one of a health care provider's diagnosis of a patient's condition and the associated health care needed for the patient's condition.

25. The method of claim 17, further comprising:
de-identifying and re-identifying the structured health care data.

26. The method of claim 25, wherein the de-identifying comprises de-identifying the structured health care data when the structured health care data is to be transmitted to an unsecure area, wherein the unsecure area comprises one of the data repository and an agency, wherein the agency comprises one of a certifying board, a licensing board, a credentialed practice location, and a commercial, research or publication customer.

27. The method of claim 25, wherein the re-identifying comprises re-identifying the structured health care data when the structured health care data is received from the data repository.

28. The method of claim 17, wherein the receiving comprises receiving the health care data comprising one of a patient's demographics, a patient's medical history, physician prescribed medications, medicine and allergy lists, laboratory test results, radiology images, billing records, a physician's diagnosis of a patient, public health reporting, clinical data, electronic prescribing, a practice management resource, patient-provided health care information, medical evidence, advertising, educational material, and a publication.

29. The method of claim 17, further comprising:
transmitting data accumulated during a health care provider's interaction with a patient to at least one credentialing body, wherein the at least one credentialing body comprises a certification board, a licensing entity, and other credentialed practice locations.

30. The method of claim 17, further comprising:
transmitting data accumulated during a health care provider's interaction with a patient to a benchmarking tool, wherein the benchmarking tool is configured to compare the accumulated data with structured health care data stored within the data repository to identify a performance change of the health care provider over time and to set future goals for performance improvements for the health care provider.

31. The apparatus of claim 17, further comprising:
transmitting the structured health care data stored within the data repository to commercial, research and publication customers for commercial purposes, health care research, and use in publications.

32. A computer program product embodied on a computer readable medium, the computer program product being configured to control a processor to perform a process, the process comprising:
receiving health care data from information sources;
assigning pre-specified content and context to each datum of the received health care data to structure the received health care data;
transmitting the structured health care data to a data repository; and
embedding a decision support tool into an electronic medical record, wherein the decision support tool comprises the structured health care data stored in the data repository.
